(19) United States
(12) Patent Application Publication
(10) Pub. No.: US 2026/0018973 A1
(43) Pub. Date: Jan. 15, 2026

(54) DETECTION OF A ROTOR POSITION

(71) Applicant: SCHAEFFLER TECHNOLOGIES AG & CO. KG, Herzogenaurach (DE)

(72) Inventors: Jochen Reith, Buhl (DE); Marco Bender, Sasbachwalden (DE); Christoph Traier, Karlsruhe (DE); Markus Gutenkunst, Lauf (DE)

(73) Assignee: SCHAEFFLER TECHNOLOGIES AG & CO. KG, Herzogenaurach (DE)

(21) Appl. No.: 18/994,838

(22) PCT Filed: Jun. 14, 2023
(86) PCT No.: PCT/DE2023/100451

§ 371 Date: Jan. 15, 2025

(30) Foreign Application Priority Data
Jul. 18, 2022 (DE) 10 2022 117 835.8

(51) Int. Cl. H02K 11/21; H02K 11/00

(52) U.S. Cl. CPC H02K 11/21; H02K 11/0094

(57) ABSTRACT

The disclosure relates to the detection of a rotor position (γ_{EM}) of an electric motor which comprises at least one stator, at least one rotor that can be rotated relative to the stator, thereby changing the rotor position (γ_{EM}), and at least two motor phases. The rotor position (γ_{EM}) is detected on the basis of a rotor position reference value (ψ_{b}) which is calculated from electric operating variables of the at least two motor phases, wherein the electric operating variables are applied to a reference system which is fixed to the stator in order to calculate the rotor position reference value (ψ_{b}). The disclosure additionally relates to an analysis device and a drive device.

### CROSS-REFERENCE TO RELATED APPLICATIONS

This application is the U.S. National Phase of PCT Appln. No. PCT/DE2023/100451, filed Jun. 14, 2023, which claims the benefit of German Patent Appln. No. 102022117835.8, filed Jul. 18, 2022, the entire disclosures of which are incorporated by reference herein.

### TECHNICAL FIELD

The disclosure relates to a rotor position detection disclosure and to an analysis device and a drive device.

### BACKGROUND

DE 10 2013 004 954 A1 describes a method for operating a multiphase electric machine having a rotor and a rotary encoder operatively connected to the rotor. An actual angle of rotation of the rotor is determined from a measured angle of rotation determined by means of the rotary encoder and an angle of rotation offset. In this case, it is provided that in order to determine the angle of rotation offset, the rotor is brought to a certain speed and then an active short-circuit of the electric machine is initiated, wherein an actual current vector is determined from the current intensities of the currents flowing in at least two of the phases of the electric machine and the measurement angle of rotation determined by means of the angle of rotation sensor using a dq transformation and the angle of rotation offset is calculated from the actual current vector and a reference current vector.

EP 3 473 346 A1 describes a method for determining a measurement offset of a rotor position sensor assigned to a rotor of an electric machine, comprising the steps of applying a short-circuit to stator windings of the electric machine, detecting currents of the stator windings in the short-circuited state, and determining the measurement offset as a function of a current vector angle in a dq reference system. The current vector angle is calculated by a phase-locked loop.

### SUMMARY

The object of the present disclosure is to detect the rotor position more accurately and reliably. The calculation effort should be reduced and the calculation should be less susceptible to fluctuations and disruptions.

At least one of these objects is achieved by a rotor position detection having the features according to claim 1. This can increase the robustness of the rotor position detection against fluctuations in the electric operating variable. Furthermore, frequency overshoots and phase overshoots can be reduced in the event of errors in the input signals. Furthermore, the rotor position can be determined more precisely. The rotor position can be determined more independently of asymmetries in the electric motor and the motor control, as well as the measurement technology.

Detecting the rotor position can result in more efficient and convenient operation of the electric motor. The rotor position is preferably a rotational position of the rotor that can be rotated relative to the stator about an axis of rotation.

The rotor position detection can be performed after the electric motor has been installed and/or before the electric motor is put into operation. The rotor position detection can be performed regularly or irregularly during operation of the electric motor.

The rotor position detection can be a check of a rotor position measured by a rotor position sensor. The measured rotor position can be corrected by the rotor position detection. A deviation of the measured rotor position from the actual rotor position can occur due to manufacturing tolerances. The deviation can be identified and/or compensated for with the rotor position detection.

The electric motor can be controlled by a motor controller. The motor controller can comprise power electronics. The motor controller can have an inverter circuit with semiconductor switching elements for controlling the electric motor. The semiconductor switching elements can be switched actively. The electric motor can have at least three motor phases. The motor controller can have a total of three half bridges. The motor controller can comprise six semiconductor switching elements.

In a preferred embodiment of the disclosure, it is advantageous if the rotor rotates relative to the stator at least during the detection of at least one of the electric operating variables. This allows the electric operating variables to be measured directly.

In a particular embodiment of the disclosure, it is advantageous if the electric motor is operated at least temporarily in active short-circuit operation or freewheel operation during the detection of at least one of the electric operating variables. Short-circuit operation or freewheel operation can be switched by the motor controller. Short-circuit operation can occur due to an electrical short-circuit of all motor phases. In short-circuit operation, half of the semiconductor switching elements can be actively switched and thus closed. In freewheel operation, all semiconductor switching elements can be unswitched and thus open.

In a particular embodiment of the disclosure, it is advantageous if at least one of the electric operating variables is detected by a short-circuit current in the short-circuit operation and/or an open-circuit voltage in freewheel operation. The open-circuit voltage can be formed by a phase voltage of at least one of the motor phases.

The rotor position reference value can be an angle of the current vector of the short-circuit current and/or an angle of the voltage vector of the open-circuit voltage in the reference system fixed to the stator. The rotor position reference value can be a difference angle between the current vector of the short-circuit current and the measured rotor position.

The rotor position can be specified by a field angle corresponding to the d-axis in the reference system fixed to the stator (dq-reference system). For example, based on the open-circuit voltages, the voltage vector of the open-circuit voltage can be offset by 90° to the field angle. In the case of an electric operating variable formed by the short-circuit current, an offset between the current vector of the short-circuit current and the field angle of 180° may exist during short-circuit operation. Alternatively, the offset between the current vector of the short-circuit current and the field angle can be detected by comparison with a reference system, in particular comprising a reference motor.

In an advantageous embodiment of the disclosure, it is provided that the rotor position is calculated by a phase-locked loop by including a feedback variable. This allows the rotor position to be calculated more accurately and independently of fluctuations and disturbances. The feedback variable can be based directly or indirectly on the measured rotor position. The feedback variable can be based directly or indirectly on the rotor position reference value.

Alternatively or additionally, the rotor position can be calculated from at least one characteristic value of the electric operating variable. The characteristic value can be a maximum, a minimum and/or a zero point. During the rotor position detection, a known relationship between the characteristic value and the actual rotor position can be used. The known relationship can be stored in a retrievable manner for rotor position detection. The rotor position can be calculated by comparing it with the known relationship. The relationship can link the actual rotor position to the characteristic value for different points in time in a time series. During the adjustment during rotor position detection, the measured rotor position can be measured for different points in time in a time series and compared with the multiple reference values of the time series of the known relationship.

The phase-locked loop can comprise at least one P-element, I-element and/or D-element carrying out the control.

In a particular embodiment of the disclosure, it is advantageous if a position measuring device is arranged to detect a measured rotor position. The position measuring device may comprise at least one rotor position sensor.

The rotor position can be calculated on the basis of a measured rotor position of the position measuring device.

In an advantageous embodiment of the disclosure, it is provided that an offset angle between the rotor position and the measured rotor position is calculated on the basis of the rotor position reference value.

In an advantageous embodiment of the disclosure, it is provided that the rotor position is calculated on the basis of the measured rotor position and the offset angle. Preferably, the offset angle for calculating the rotor position is stored in a retrievable manner during operation of the electric motor. The rotor position can be calculated as the sum or difference between the measured rotor position and the offset angle. During the calculation, filtered, in particular averaged values of the measured rotor position can be used to form the difference or the sum and/or the difference or the sum can be filtered, in particular averaged, over several values. The rotor position can also be calculated under different operating conditions. The offset angle can be formed on the basis of the operating condition.

Furthermore, at least one of the previously specified objects is achieved by an analysis device having a first receiving unit receiving the measured rotor position, a second receiving unit receiving the at least one electric operating variable, and a calculation unit carrying out the method with at least one of the previously described features. A unit is understood to be a device-side implementation that is physically present. The different units can be structurally separated from each other or structurally combined.

Furthermore, at least one of the above-mentioned objects is achieved by a drive device having an electric motor which comprises at least one stator and at least one rotor that can be rotated relative to the stator, thereby changing the rotor position, and at least two motor phases and an analysis device as described above. The drive device can be arranged in a vehicle. The electric motor can provide drive torque to propel the vehicle.

Further advantages and advantageous embodiments of the disclosure arise from the description of the figures and the drawings.

### BRIEF DESCRIPTION OF THE DRAWINGS

The disclosure is described in detail below with reference to the drawings. In the drawings, in detail:

FIG. 1: shows an electric motor of a drive device in a particular embodiment of the disclosure.

FIG. 2: shows a drive device in a particular embodiment of the disclosure.

FIG. 3: shows a rotor position detection in a particular embodiment of the disclosure.

FIG. 4: shows a method for determining the deviation for a rotor position detection in a further particular embodiment of the disclosure.

FIG. 5: shows a method for determining the deviation for a rotor position detection in a further particular embodiment of the disclosure.

FIG. 6: shows an alternative method for determining the deviation for a rotor position detection in a further particular embodiment of the disclosure.

FIG. 7: shows a rotor position detection in a further particular embodiment of the disclosure.

FIG. 8: shows a rotor position detection in a further particular embodiment of the disclosure.

### DETAILED DESCRIPTION

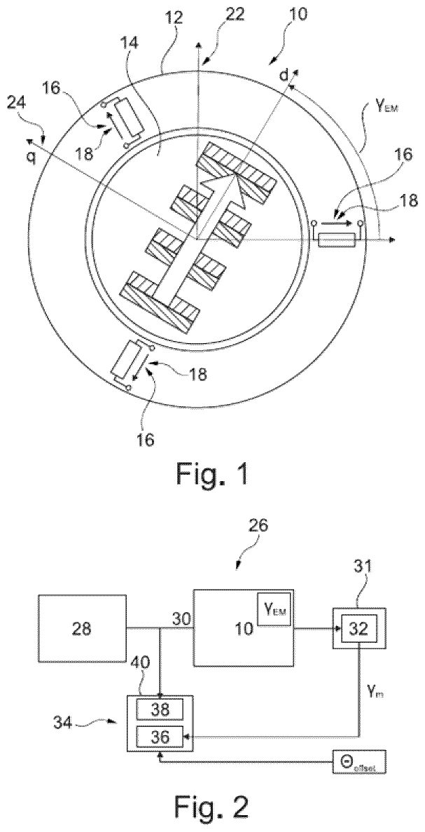

FIG. 1 shows an electric motor of a drive device in a particular embodiment of the disclosure. The electric motor 10 comprises a stator 12 and a rotor 14 which can be rotated relative to the stator about an axis of rotation, as well as three motor phases 16 to which a respective phase voltage 18 is applied for operating the electric motor 10. When the rotor 14 rotates relative to the stator 12, the rotor position γ_{EM} changes, which is a rotational position of the rotor 14 relative to the stator 12. The electric operating variables present during operation of the electric motor 10 can be described in a reference system 22 which is fixed to the stator with an axis in the direction of a coil or in a reference system 24 which is fixed to the stator which rotates relative to the reference system 22 which is fixed to the stator at a rotational speed. The reference system 24 which is fixed to the rotor is spanned by a d-axis characterizing the magnetic flux density and a q-axis perpendicular thereto and representing the torque. The d-axis spans a field angle corresponding to the rotor position γ_{EM} in relation to the axis along the coil of the reference system 24 which is fixed to the rotor.

FIG. 2 shows a drive device in a particular embodiment of the disclosure. The drive device 26 comprises the electric motor 10, a motor controller 28 for controlling the electric motor 10 via at least one electric operating variable 30, a position measuring device 31 with a rotor position sensor 32 for detecting a measured rotor position γₘ and an analysis device 34 with a first receiving unit 36 receiving the measured rotor position γₘ and a second receiving unit 38 receiving the electric operating variable 30 and a calculation unit 40 processing the measured rotor position γₘ and the electric operating variable 30.

The measured position γₘ can, for example, deviate from the actual rotor position γ_{EM} by an offset angle Θ_{offset} due to manufacturing tolerances. This deviation of the rotor position must in particular be determined in advance and compensated for during operation of the electric motor 10 in order to identify the actual rotor position γ_{EM} during operation of the electric motor 10 and to operate the electric motor 10 as efficiently as possible with knowledge thereof.

For example, the offset angle Θ_{offset} can be stored and accessed during operation of the electric motor 10 to determine the actual rotor position γ_{EM}.

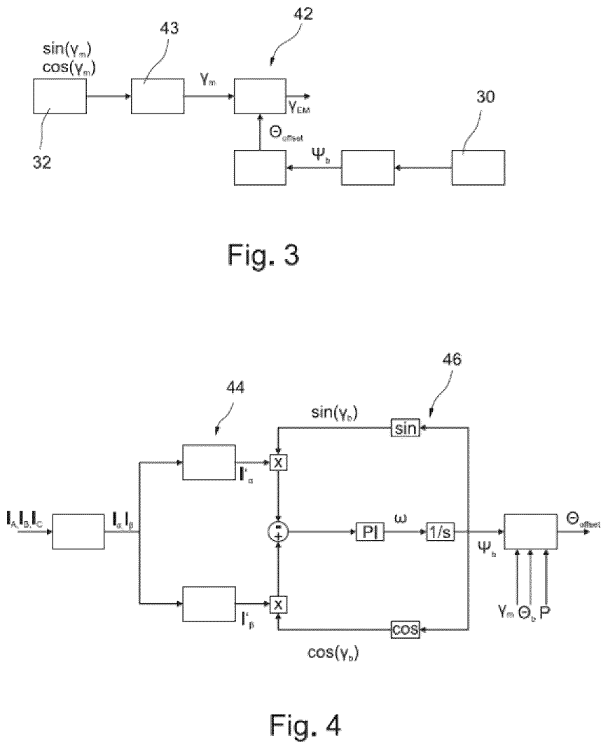

FIG. 3 shows a rotor position detection in a particular embodiment of the disclosure. With the rotor position detection 42 carried out during operation of the electric motor, a measured rotor position γₘ of the rotor position sensor can be used to calculate the actual rotor position γ_{EM}, for example by converting the measured values sin(γₘ) and cos(γₘ) of the rotor position sensor 32 into the measured rotor position γₘ using a position calculation 43. The offset angle Θ_{offset} determined from the electric operating variables is then used to calculate the actual rotor position γ_{EM} from the measured rotor position γₘ.

The offset angle Θ_{offset} can be detected during operation of the electric motor or calculated before operation, in particular before the electric motor is put into operation for the first time. For this purpose, a rotor position reference value ψ_{b} is used to calculate the offset angle Θ_{offset} on the basis of electric operating variables 30 of at least two motor phases, in particular of three motor phases.

The offset angle Θ_{offset} can be determined from the electric operating variables 30 as explained in detail below.

FIG. 4 shows a method for determining a deviation for a rotor position detection in a further particular embodiment of the disclosure. The method for determining a deviation 44 is performed, for example, after assembly and before the electric motor is put into operation.

The electric motor is switched into short-circuit operation or freewheel operation by the motor controller. The method for determining a deviation 44 will be explained below using the example of short-circuit operation. The electric operating variables 30 are each formed by short-circuit currents during short-circuit operation.

The short-circuit currents Ia, Ib, Ic of the three motor phases are detected and form the electric operating variables 30. The short-circuit currents Ia, Ib, Ic are initially referred to an αβ reference system fixed to the stator as transformed short-circuit currents I_{α}, I_{β}. The transformed short-circuit currents I_{α}, I_{β} are normalized and used as normalized short-circuit currents I′_{α}, I′_{β}.

In a subsequent phase-locked loop 46 using a PI controller and the rotor speed ω, from the normalized short-circuit currents I′_{α}, I′_{β} the current angle γₛ of the current vector in the reference system fixed to the stator is calculated as the rotor position reference value ψ_{b}. The offset angle Θ_{offset} is then calculated from the rotor position reference value ω_{b} and the measured rotor position γₘ and a current reference angle Θ_{b} determined in advance on a reference motor as the angle between the current vector and the rotor position γ_{EM} as well as at least one operating parameter P of the electric motor. The offset angle Θ_{offset} can be determined via the operating parameter P on the basis of the operating state of the electric motor.

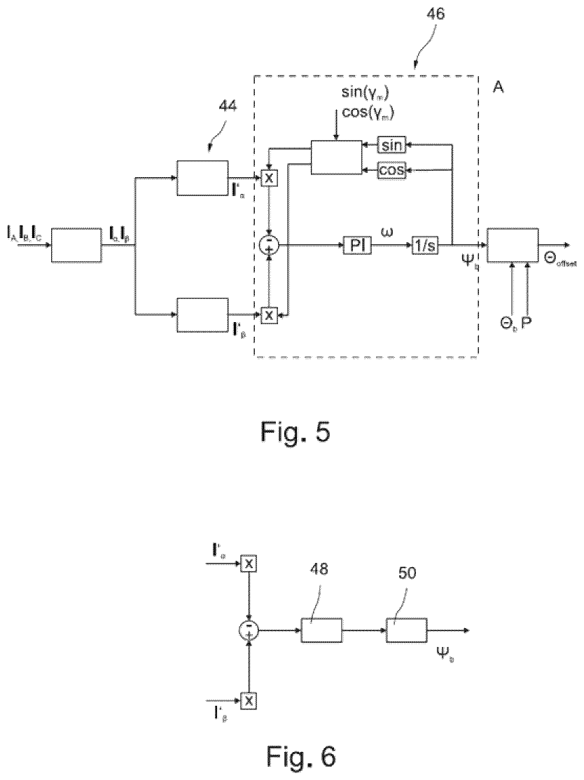

FIG. 5 shows a method for determining the deviation for a rotor position detection in a further particular embodiment of the disclosure. The method for determining the deviation 44 is similar to that in FIG. 4 except for the differences described below. In the phase-locked loop 46, the measured rotor position γₘ is used.

This allows a difference angle between the measured rotor position γ_{b} and the current angle γₛ to be calculated as a rotor position reference value ψ_{b} and then the offset angle Θ_{offset} to be calculated on the basis of the current reference angle Θ_{b} and at least one operating parameter P of the electric motor.

FIG. 6 shows an alternative method for determining the deviation for a

rotor position detection in a further particular embodiment of the disclosure. The section A shown in FIG. 5 is designed alternatively. Instead of the phase-locked loop, the rotor position reference value ψ_{b} using an open loop with filtering 48 and subsequent correction 50 of systematic errors.

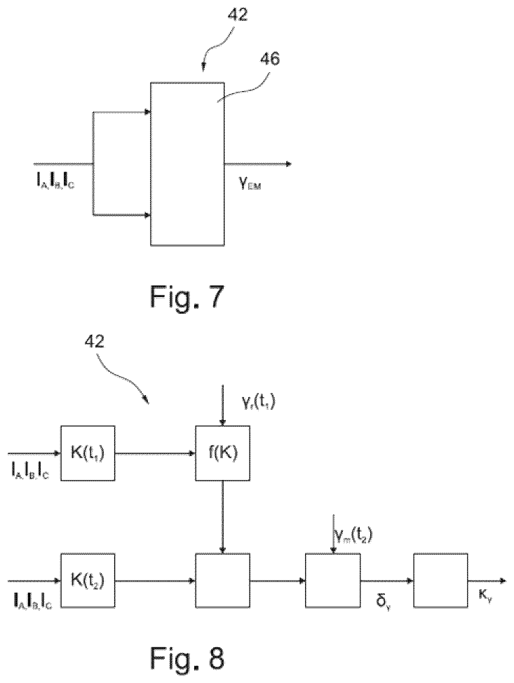

FIG. 7 shows a rotor position detection in a further particular embodiment of the disclosure. The rotor position detection 42 is similar to that of FIG. 3, but instead of the transformed short-circuit currents in the αβ reference system, the short-circuit currents Ia, Ib, Ic are used directly as input variables. From the short-circuit currents Ia, Ib, Ic, the rotor position γ_{EM} is calculated in a subsequent phase-locked loop 46.

FIG. 8 shows a rotor position detection in a further particular embodiment of the disclosure. The rotor position detection 42 is carried out with the short-circuit currents Ia, Ib, Ic, which are related to the reference system which is fixed to the stator and represent the electric operating variables. For the harmonic short-circuit currents Ia, Ib, Ic, at least one characteristic value K of the short-circuit currents Ia, Ib, Ic is detected. The characteristic value K can be a maximum, minimum and/or a zero point of the harmonic short-circuit currents Ia, Ib, Ic. The rotor position γ_{EM} is calculated by using a known relationship f(K) between the actual rotor position as a reference position γᵣ and the characteristic value K, for example by prior measurement on a reference system, in particular on a reference motor, to obtain the rotor position γ_{EM} from the characteristic value K. For this purpose, at the point in time t₁ at which the characteristic value K occurs, the actual rotor position is also detected as a reference position γᵣ and linked to the characteristic value K. The relationship f(K) can depend on various parameters, such as the rotor speed or the temperature.

In the electric motor, the measured rotor position γₘ is detected at the time t_{w} at which the characteristic value K occurs and the deviation δ_{γ} between the rotor position γ_{EM} and the measured rotor position γₘ is converted into a correction value κ_{γ}. As an alternative to measuring at a single point in time t₂ for which the characteristic value K occurs, a time series of reference positions γᵣ can also be detected. The measured rotor position γₘ can also be detected in a time series and thus the deviation δ_{γ} can be calculated for different points in time in the time series.

### LIST OF REFERENCE SYMBOLS

10 Electric motor
12 Stator
14 Rotor
16 Motor phase
18 Phase voltage
22 Reference system fixed to the stator
24 Reference system fixed to the rotor
26 Drive device
28 Motor controller
30 Electric operating variables
31 Position measuring device
32 Rotor position sensor
34 Analysis device
36 First receiving unit
38 Second receiving unit
40 Calculation unit
42 Rotor position detection
43 Position calculation
44 Method for determining a deviation
46 Phase-locked loop
48 Filtering
50 Correction
f(K) Relationship
K Characteristic value
δ_{γ} Deviation
γ_{EM} Rotor position
γₘ Measured rotor position
γᵣ Reference position
ψ_{b} Rotor position reference value
κ_{γ} Correction value
ω Rotor speed
Θ_{offset} Offset angle
Θ_{b} Current reference angle
P Operating parameter
t₁ Point in time
t₂ Point in time

1. A rotor position detection method for detecting of a rotor position (γ_{EM}) of an electric motor, the electric motor having
at least one stator and at least one rotor that can be rotated relative to the stator, thereby changing the rotor position (γ_{EM}), and at least two motor phases, the method comprising:
detecting at least one operating variable of the at least two motor phases, wherein
the rotor position (γ_{EM}) is detected on a basis of a rotor position reference value (ψ_{b}) which is calculated from the at least one electric operating variable of the at least two motor phases, wherein
the at least one electric operating variable is applied to a reference system which is fixed to the stator in order to calculate the rotor position reference value (ψ_{b}).

2. The rotor position detection method according to claim 1, wherein at least during the detection of at least one of the electric operating variable the rotor rotates relative to the stator.

3. The rotor position detection method according to claim 1, wherein the electric motor is operated at least temporarily in active short-circuit operation or freewheel operation during the detection of at least one of the electric operating variable.

4. The rotor position detection according to claim 3, wherein at least one of the electric operating variable is detected by at least one of a short-circuit current in short-circuit operation or an open-circuit voltage in freewheel operation.

5. The rotor position detection method according to claim 1, wherein the rotor position (γ_{EM}) is calculated on a basis of a measured rotor position (γₘ) of a position measuring device.

6. The rotor position detection method according to claim 5, wherein an offset angle (Θ_{offset}) between the rotor position (γ_{EM}) and a measured rotor position (γₘ) is calculated on a basis of the rotor position reference value (ψ_{b}).

7. The rotor position detection method according to claim 6, wherein the rotor position (γ_{EM}) is calculated on a basis of the measured rotor position (γₘ) and the offset angle (Θ_{offset}).

8. The rotor position detection method according to claim 6, wherein the offset angle (Θ_{offset}) for calculating the rotor position (γ_{EM}) during operation of the electric motor is stored in a retrievable manner.

9. An analysis device for an electric motor having at least one stator and at least one rotor that can be rotated relative to the stator, thereby changing the rotor position (γ_{EM}), and at least two motor phases and an analysis device. the analysis device comprising a first receiving unit for receiving a measured rotor position (γₘ), a second receiving unit for receiving at least one electric operating variable, and a calculation unit carrying out the rotor position detection method according to claim 1.

10. A drive device comprising an electric motor having at least one stator and at least one rotor that can be rotated relative to the stator, thereby changing the rotor position (γ_{EM}), and at least two motor phases, and an analysis device, wherein the analysis device includes a first receiving unit for receiving a measured rotor position (γₘ), a second receiving unit for receiving at least one electric operating variable, and a calculation unit.

11. The drive device according to claim 10, wherein the analysis device is configured to detect the rotor position (γ_{EM}) on a basis of a rotor position reference value (ψ_{b}) which is calculated from the at least one electric operating variable of the at least two motor phases, wherein the at least one electric operating variable is applied to a reference system which is fixed to the stator in order to calculate the rotor position reference value (ψ_{b}).

12. The analysis device according to claim 9, wherein the analysis device is configured to detect the rotor position (γ_{EM}) on a basis of a rotor position reference value (ψ_{b}) which is calculated from the at least one electric operating variable of the at least two motor phases, wherein the at least one electric operating variable is applied to a reference system which is fixed to the stator in order to calculate the rotor position reference value (ψ_{b}).
